(19) United States
(12) Patent Application Publication
(10) Pub. No.: US 2023/0329485 A1
(43) Pub. Date: Oct. 19, 2023

(54) ICE CREAM SCOOP SYSTEMS AND METHODS THEREOF

(71) Applicant: KEY SYSTEMS, INC., Fishers, NY (US)

(72) Inventor: George ECKERDT, Victor, NY (US)

(21) Appl. No.: 18/134,855

(22) Filed: Apr. 14, 2023

Related U.S. Application Data
(60) Provisional application No. 63/331,382, filed on Apr. 15, 2022.

(51) Int. Cl. A47J 43/28

(52) U.S. Cl. CPC A47J 43/282

(57) ABSTRACT

An ice cream scooping system includes an ice cream scooping device with a handle and a bowl located at one end of the handle and which has inner and outer surfaces and an outer rim. An ultrasonic generation system is coupled to at least a portion of the bowl and has at least an engaged state configured to generate ultrasonic waves and a disengaged state without the generation of the ultrasonic waves.

This application claims the benefit of U.S. Provisional Patent Application Ser. No. 63/331,382, filed Apr. 15, 2022, which is hereby incorporated by reference in its entirety.

### FIELD

This technology relates to ice cream scoop systems and methods thereof.

### BACKGROUND

Ice cream is a favorite dessert, particularly in the United States, where the average person consumes more than twenty-three quarts of ice cream every year. Ice cream, as used in the examples in this application includes all types of solid or semi-solid frozen desserts including without limitation sorbet, gelato, frozen fruit treats, flavored ice treats, ice milk, and soy milk based frozen treats. Often ice cream is solidified in a churn and frozen at a temperature that would cause the ice cream to be solid or semi-solid state. Typically, this produced ice cream is stored in cartons, buckets or other sealable containers of various sizes and configurations.

When served in individual portions, ice cream is often scooped into ball shapes often referred to as “scoops” with a scooping device. This scooping device is a type of spoon typically having a handle connected to a bowl. The bowl is shaped to produce a round shaped ball of ice cream when the scooping device is passed across the surface of the ice cream in the storage container.

Unfortunately, scooping ice cream with a traditional scooping device requires a substantial force to move the scoop through the frozen media. Personnel involved with constant dispensing develop Carpal tunnel syndrome which is a condition that causes numbness, tingling, and pain in the hand and forearm. In most patients, carpal tunnel syndrome gets worse over time. If untreated for too long, it can lead to permanent dysfunction of the hand, including loss of sensation in the fingers and weakness.

Additionally, when scooping ice cream with a traditional scooping device the ice cream often freezes to the bowl of the scooping device hindering the release of the ice cream from the scooping device. As a result, to dislodge the ice cream from the bowl of the scooping device often another spoon or utensil is needed to release the ice cream from the bowl of the scooping device or in unnecessary handling and potential contamination. Further, the steps needed to release the ice cream from the bowl of the scooping device can damage the final presentation of the scooped ice cream. Accordingly, these difficulties extend the time and required effort needed to obtain a scoop of ice cream which decreases throughput as well as damages the resulting presentation of the scooped ice cream which is undesirable, particularly for commercial applications.

To make scooping easier, ice cream is often kept at a temperature closer to 32° F. (0° C.) which is not desirable. Additionally, a container of water (sometimes warm) is often kept close and used to store at least the bowl of the scooping device. The water keeps the bowl of the scooping device above freezing and cleans away any ice cream that sticks to the bowl after delivery. Unfortunately, to do this, the water must be replaced frequently which wastes water and is inefficient.

Other attempted solutions have incorporated a heated bowl on the scooping device which requires less force to obtain a scoop of ice cream and helps to keep the ice cream from sticking to the bowl, but results in a melted surface on the ice cream that is scooped resulting in an undesirable presentation and unnecessary loss of ice cream.

### SUMMARY

An ice cream scooping system includes an ice cream scooping device with a handle and a bowl located at one end of the handle and which has inner and outer surfaces and an outer rim. An ultrasonic generation system is coupled to at least a portion of the bowl and has at least an engaged state configured to generate ultrasonic waves and a disengaged state without the generation of the ultrasonic waves.

A method for making an ice cream scooping system includes providing a bowl located at one end of a handle of an ice cream scooping device and which has inner and outer surfaces and an outer rim. An ultrasonic generation system is coupled to at least a portion of the bowl and has at least an engaged state configured to generate ultrasonic waves and a disengaged state without the generation of the ultrasonic waves.

This technology provides a more effective and efficient ice cream scooping system which minimizes necessary effort as well as loss or presentation of scooped ice cream. With examples of this technology, ice cream, including ice cream frozen at temperatures below 32° F. (0° C.), can be easily scooped out of a container with the ice cream scooping device without any issue of ice cream sticking to the ice cream scooping device. Additionally, this ice cream scooping device is able to scoop out the ice cream with less melt than occurs with prior heated ice cream scooping devices. Further, because ice cream can be repeatedly scooped out more easily with this ice cream scooping device there is less risk of developing Carpal tunnel syndrome. Examples of this ice cream scooping device utilize ultrasonic wave energy which immediately changes the molecular state of the frozen ice cream to a liquid directly adjacent to the bowl of the ice scream scooping device without a traditional heating element. The bowl of the ice cream scooping device does not become warm. Further, this ice cream scooping device is able to self-clean without the need of excessive amounts or hot water or other cleaning fluids or towels increasing scooping throughput while eliminating cross contamination.

### BRIEF DESCRIPTION OF THE DRAWINGS

FIG. 1 is a perspective view of an example of an ice cream scoop system having an ice cream scoop device and a charging station.

FIG. 2 is a perspective view of another example of an ice cream scoop device.

FIG. 3 is an elevated front view of the example of the ice cream scoop device shown in FIG. 1.

FIG. 4 is a cut away view of the example of the ice cream scoop device shown in FIG. 3 taken along the line 4-4.

FIG. 5 is a circuit diagram of the example of the ice cream scoop system shown in FIG. 1.

FIG. 6 are diagrams of examples of horn shapes for the lead-free piezoelectric material and an exemplary table of gains and stress.

FIG. 7 is a graph of an example of displacement versus power for different horn shapes for the lead-free piezoelectric material.

### DETAILED DESCRIPTION

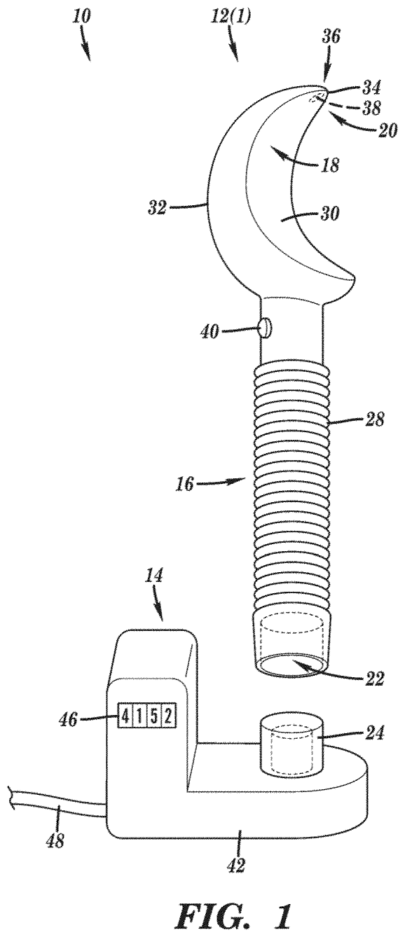

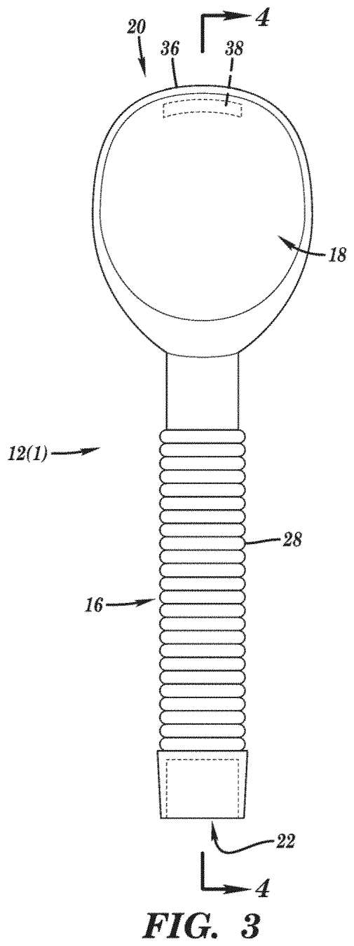

An example of an ice cream scoop system 10 is illustrated in FIGS. 1 and 3-5, although other configurations of the system can be used. In this example, the ice cream scoop system 10 includes an ice cream scooping device 12(1) and a charging station 14, although the system could include other types of systems, devices, components, and/or other elements in other configurations. This technology provides a more effective and efficient ice cream scooping system which minimizes necessary effort as well as loss or presentation of scooped ice cream.

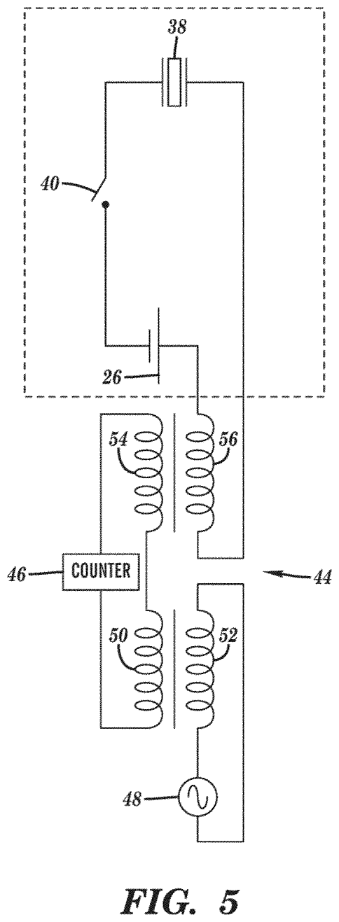

In this example, the ice cream scooping device 12(1) includes a handle 16, a bowl 18, and an ultrasonic generation system 20, although the ice cream scooping device 12(1) could include other types of systems, devices, components, and/or other elements in other configurations. One end of the handle 16 is affixed to the bowl 18, although the handle 16 and bowl 18 could have other configurations and/or could be manufactured in other manners, such as the handle 16 and bowl 18 having a unitary construction by way of example only. An opposing end of the handle 16 has an optional opening 22 shaped and designed to mate with a projection 24 of the charging station 14 to facilitate charging of the power source 26 as illustrated and described in greater detail with reference to FIG. 5 herein, although other manners for positioning and/or coupling the power source 26 for charging by a charging station may be used. The handle 16 may also have an optional grip 28, such as a rubber, ribbed grip by way of example only, located about at least a portion of the handle 16.

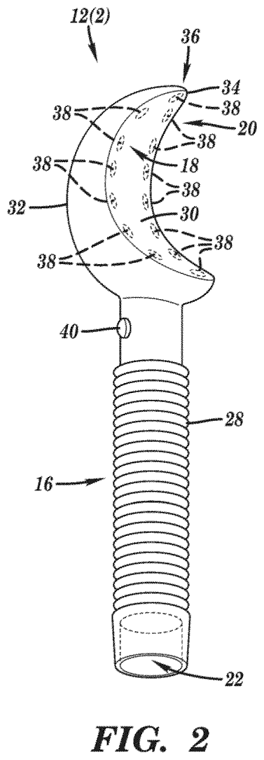

The bowl 18 includes an inner surface 30, an outer surface 32, and an outer rim 34, although the bowl could have other elements and/or other configurations. In this example, the inner surface 30 has a concave shape and the outer surface 32 has a convex shape that each come to a tapered point 36 to facilitate scooping of ice cream, although the bowl 18 could have other numbers of surfaces and/or other configurations. The inner and outer surfaces 30 and 32 also meet at an outer rim 34 of an open end of the bowl 18 along which a sealed seam can be formed by a weld or other sealing mechanism, such as an adhesive, although the inner and outer surfaces 30 and 32 could be joined together in other manners. Additionally in this example in ice cream scoop system 10(1), the inner and outer surfaces 32 and 34 are spaced apart to form a space for at least part of the ultrasonic generation system 20, although as illustrated and described by way of other examples herein part or all of the ultrasonic generation system 20 can be in other locations on or about the bowl 18, such as shown in ice cream scoop system 10(2) in FIG. 2 by way of example. Further, in this example the first and second surfaces 30 and 32 may be made of metal, such as food grade aluminum or food grade stainless steel by way of example only, although other types and/or numbers of other materials, such as plastics or other polymers by way of example, may be used.

The ultrasonic generation system 20 includes the power source 26, an ultrasonic transmitter 38, and an engagement system 40, although the ultrasonic generation system may comprise other types and/or numbers of other systems, devices, components and/or other elements in other configurations. In this example the power source 26 is a rechargeable battery located inside the handle 16, although other types of power sources may be used, such as a disposable battery by way of example only, and/or the power source may be in other locations.

In this example, the ultrasonic transmitter 38 is located between the inner and outer surfaces 30 and 32 and adjacent at least a portion of the outer rim 34 which forms a leading edge by the tapered point 36 of the bowl 18 opposite from the handle 16, although other numbers and/or locations for the ultrasonic transmitter 38 may be used. In this location along the leading edge, the ultrasonic transmitter 38, when in an engaged state, can generate ultrasonic waves to facilitate scooping of ice cream as well as cleaning of the bowl 18 as illustrated and described in the examples herein. In this example, the ultrasonic transmitter 38 comprises a piezoelectric device with a piezoelectric crystal between electrodes of opposing polarities, although other types of ultrasonic transmitters may be used.

By way of example, an alternative example of an ice cream scooping device 12(2) is shown in FIG. 2 and works with charging station 14. The ice cream scooping device 12(2) is the same in structure and operation as the ice cream scooping device 12(1), except as otherwise illustrated and described herein. Elements in ice cream scooping device 12(2) which are like those in ice cream scooping device 12(1) have like reference numerals. In the ice cream scooping device 12(2), the ultrasonic transmitters 38 are shown between the inner and outer surfaces 30 and 32 and about the outer rim 34 of the bowl 18 to form a ring shape and also have one ultrasonic transmitter 38 located on an outer surface 32 of the bowl 18, although the ultrasonic transmitters 38 could be in other configurations in and/or on the bowl 18. In this example, each of the ultrasonic transmitters 38 is coupled to the power source 26 and the operational state is managed by the engagement system 40, although other manners for controlling one or more of the ultrasonic transmitters 38 may be used.

Referring back to FIGS. 1-5, the engagement system 40 for ice cream scooping devices 12(1) and 12(2) is coupled between each of the one or more ultrasonic transmitters 38 and the power source 26 and is configured to switch the ultrasonic generation system 20 between at least the engaged state and the disengaged state, although other types and/or numbers of engagement systems in other configurations may be used. In this example, the engagement system 40 comprises a button switch which can be manually engaged by an operator from a disengaged state to an engaged state. In the engaged state, power is provided to the one or more ultrasonic transmitters 38 which generate and transmit ultrasonic waves which facilitate the ice cream scooping devices 12(1) and 12(2) scooping ice cream. In the disengaged state, power is cut off to the one or more ultrasonic transmitters 38 and no ultrasonic waves are generated and transmitted, although other types and/or numbers of operational states may be used.

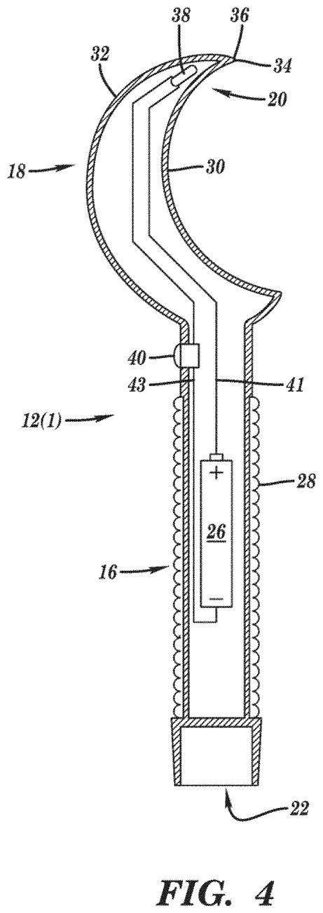

Referring to FIG. 4, a cut away view of an example of ice cream scooping device 12(1) illustrates an example of these connections. In this example, the ultrasonic transmitter 38 has a piezoelectric crystal is connected to a positive wire 41 and negative wire 43 coupled to positive and negative terminals of the power source 26 with an engagement device 40 coupled in series in the positive wire 41, although other types of configurations could be used.

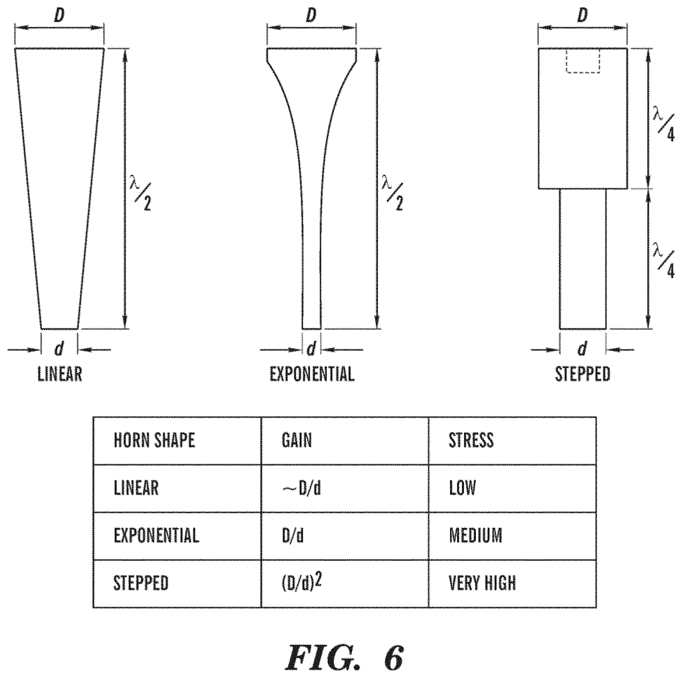

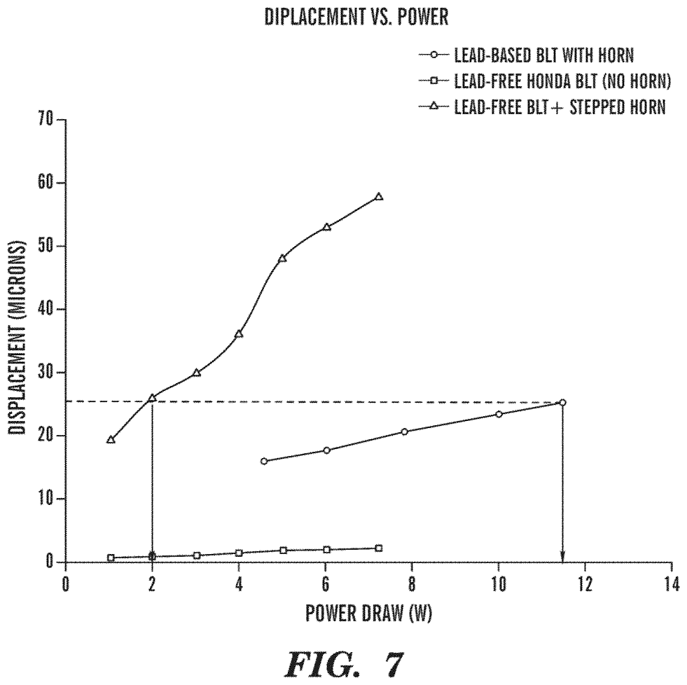

In these examples for the ice cream scooping devices 12(1) and 12(2), each of the ultrasonic transmitters 38 is made of a lead-free piezoelectric material, such as a KNN-type piezoceramic like (Ba,Ca), (Ti,Zr)O3 and incipient piezo-electric materials by way of example only, to avoid any contact and possible lead contamination of the food product being scooped out. Additionally, the shape of the lead-free piezoelectric material for the ultrasonic transmitter 38 can vary, such as between a linear, exponential or stepped shape as shown in FIG. 6. In particular, the stepped horn shape for the lead-free piezoelectric material for the ultrasonic transmitter 38 mostly closely matches a leaded piezoelectric material and with lower power requirements as shown in FIGS. 6 and 7.

Referring to FIGS. 1 and 5, the charging station 14 has a housing 42, charging circuitry 44, and an optional counting system 46, although the charging station 14 could have other types and/or numbers of other systems, devices, components, and/or other elements in other configurations. In this example, the housing 42 includes the projection 24 shaped to detachably mate with the opening 22 of the handle 16 and which contains charging circuitry 44, although the housing may have other configurations and house other types and/or numbers of other systems, devices, components, and/or other elements.

Referring to FIGS. 4 and 5, the charging circuitry 44 includes induction coils 50 and 52 and rectifier coils 54 and 56, although the charging circuitry 44 could have other types and/or numbers of other systems, devices, components, and/or other elements in other configurations. In this example, an external alternating current power source 48 is coupled to and converted to a direct current by rectifier coils 54 and 56. This direct current flows through the induction coil 54 and when the opening 22 in the handle 16 of the ice cream scooping device 12(1) or 12(2) is placed on the projection 24 of the charging station 14, then the induction coil 56 is placed in close proximity with the induction coil 54 and current is induced in the induction coil 56 which is coupled to the power source 26, a rechargeable battery in this example, which is charged.

The counting system 46 is configured to provide maintain an updated count of each time the ice cream scooping device 12(1) or 12(2) is removed from the charging system 14. In this example, the counting system 46 includes a display of this number, although other manners of outputting the count could be used. The counting system 46 can help keep track of inventory by counting each time ice cream is served.

Referring to FIGS. 1-5, an example of method of using one of the ice cream scooping devices 12(1) or 12(2) is set forth below. In this example, when an operator removes the one of the exemplary ice cream scooping devices 12(1) or 12(2) form the charging station 14, then the counting system 46 is configured to increment the displayed count by one.

Next, when the operator presses the engagement device 40 comprising a button switch in this example, then the circuit is closed and the ultrasonic generator system 20 transitions from a disengaged state to an engaged state. In the engaged state, power flows from the power source 26 to the ultrasonic transmitter 38 which generates and transmits ultrasonic waves.

When the operator places the leading edge of the bowl 16 into the ice cream, the ultrasonic waves from the one or more ultrasonic transmitters 38 cause an ultrasonic percussion wave. The ultrasonic percussion wave resonates with hydrogen bonds that form water crystals in the ice cream which melts a thin layer of the ice cream. In this example, a thin layer means less than 1 mm and in other examples is configured to be less than 0.8 mm and in other examples is adjusted to be less than 0.6 mm. Accordingly, with this ultrasonic percussion wave the effort required to scoop ice cream is reduced as well as any melt of the ice cream and the resulting appearance of the scooped ice cream is substantially preserved because melt is minimized.

Once the operator has completed scooping the ice cream, the engagement device 40 can be released to the disengaged state which then retains the ice cream in the bowl 18 of the one of the exemplary ice cream scooping devices 12(1) or 12(2). When the operator has the one of the exemplary ice cream scooping devices 12(1) or 12(2) moved to the desired position to dispense, such as to a particular cone or bowl by way of example, the engagement device 40 can be activated to turn on the engaged state of the ultrasonic generation system 20 which generates and transmits the ultrasonic waves and releases the scooped ice cream.

To clean the bowl and avoid any cross contamination, the operator can either continue to hold or if in a disengaged state can activate the engagement device 40 to the engaged state. Accordingly, when the engagement device 40 is activated to the engaged state, then the ultrasonic generation system 20 generates and transmits ultrasonic waves that cause the release of any remaining ice cream or other debris, such as residual toppings by way of example, from the bowl 18. Accordingly, the one of the exemplary ice cream scooping devices 12(1) or 12(2) can be cleaned without water or other cleaning equipment.

Once the operator has completed any necessary actions, the one of the exemplary ice cream scooping devices 12(1) or 12(2) may be positioned to mate the opening 22 with the projection 24 which aligns the rectifier coils 50 and 52. In this example again, when aligned an external alternating current power source 48 is coupled to and converted to a direct current by these rectifier coils 54 and 56. This direct current flows through the induction coil 54 and is induced in the induction coil 56 which is coupled to the power source 26, a rechargeable battery in this example, which is charged.

Accordingly, as illustrated and described by way of the examples herein, this technology provides an ice cream scooping system that uses an ultrasonic wave generator to reduce force necessary to remove a serving of ice cream from a mass of ice cream in a container and to assist with cleaning the ice cream scooping device. Again, with examples of this technology, ice cream, including ice cream frozen at temperatures below 32° F. (0° C.), can be easily scooped out of a container with the ice cream scooping device without any issue of ice cream sticking to the ice cream scooping device. Additionally, this ice cream scooping device is able to scoop out the ice cream with less melt than occurs with prior heated ice cream scooping devices. Further, this ice cream scooping device is able to self-clean without the need of water or other cleaning fluids or towels increasing scooping throughput while eliminating cross contamination.

Having thus described the basic concept of the invention, it will be rather apparent to those skilled in the art that the foregoing detailed disclosure is intended to be presented by way of example only and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations, therefore, is not intended to limit the claimed processes to any order except as may be specified in the claims. Accordingly, the invention is limited only by the following claims and equivalents thereto.

What is claimed is:

1. An ice cream scooping system comprising:
an ice cream scooping device comprising:
a handle;
a bowl located at one end of the handle, the bowl having inner and outer surfaces and an outer rim; and
an ultrasonic generation system coupled to at least a portion of the bowl, the ultrasonic generation system having at least an engaged state configured to generate ultrasonic waves and a disengaged state without the generation of the ultrasonic waves.

2. The system as set forth in claim 1 wherein the ultrasonic generation system further comprises:
one or more ultrasonic transmitters coupled to the bowl adjacent at least a portion of the outer rim which forms a leading edge of the bowl opposite from the handle.

3. The system as set forth in claim 2 wherein the one or more ultrasonic transmitters comprise a plurality of the ultrasonic transmitters coupled to the bowl to form a ring about the outer rim of the bowl.

4. The system as set forth in claim 2 wherein the one or more ultrasonic transmitters comprise one or more piezoelectric devices.

5. The system as set forth in claim 4 wherein the one or more piezoelectric devices are one or more lead-free piezoelectric devices.

6. The system as set forth in claim 4 wherein the one or more lead-free piezoelectric devices have a stepped-shape.

7. The system as set forth in claim 2 wherein the one or more ultrasonic transmitters are mounted in the bowl between the inner and outer surfaces.

8. The system as set forth in claim 2 wherein the one or more ultrasonic transmitters are mounted on the outer surface of the bowl.

9. The system as set forth in claim 2 wherein the ultrasonic generation system further comprises:
a power source; and
an engagement system coupled between the one or more ultrasonic transmitters and the power source, the engagement system configured to switch the ultrasonic generation system between at least the engaged state and the disengaged state.

10. The system as set forth in claim 9 further comprising:
a charging station configured to detachably couple to and charge the power source.

11. The system as set forth in claim 10 wherein the charging system further comprises:
a counting system configured to provide maintain an updated count of each time the ice cream scooping device is removed from the charging system.

12. The system as set forth in claim 10 wherein the power source comprises a recharge chargeable battery disposed in the handle.

13. A method for making an ice cream scooping system, the method comprising:
providing a bowl located at one end of a handle of an ice cream scooping device, the bowl having inner and outer surfaces and an outer rim; and
coupling an ultrasonic generation system to at least a portion of the bowl, the ultrasonic generation system having at least an engaged state configured to generate ultrasonic waves and a disengaged state without the generation of the ultrasonic waves.

14. The method as set forth in claim 13 wherein the coupling the ultrasonic generation system further comprises:
coupling one or more ultrasonic transmitters to the bowl adjacent at least a portion of the outer rim which forms a leading edge of the bowl opposite from the handle.

15. The method as set forth in claim 14 wherein the coupling the one or more ultrasonic transmitters further comprises coupling a plurality of the ultrasonic transmitters to form a ring about the outer rim of the bowl.

16. The method as set forth in claim 14 wherein the one or more ultrasonic transmitters comprise one or more piezoelectric devices.

17. The method as set forth in claim 16 wherein the one or more piezoelectric devices are lead-free piezoelectric devices.

18. The method as set forth in claim 17 wherein the one or more lead-free piezoelectric devices have a stepped-shape.

19. The method as set forth in claim 14 wherein the coupling the one or more ultrasonic transmitters further comprises mounting the one or more ultrasonic transmitters in the bowl between the inner and outer surfaces.

20. The method as set forth in claim 14 wherein the coupling the one or more ultrasonic transmitters further comprises mounting the one or more ultrasonic transmitters on the outer surface of the bowl.

21. The method as set forth in claim 14 wherein the coupling the ultrasonic generation system further comprises:
providing a power source; and
coupling an engagement system between the one or more ultrasonic transmitters and the power source, the engagement system configured to switch the ultrasonic generation system between at least the engaged state and the disengaged state.

22. The method as set forth in claim 21 further comprising:
providing a charging station configured to detachably couple to and charge the power source in the ice cream scooping device.

23. The method as set forth in claim 22 wherein the providing the charging system further comprises:
providing a counting system configured to provide maintain an updated count of each time the ice cream scooping device is removed from the charging system.

24. The method as set forth in claim 22 wherein the power source comprises a recharge chargeable battery disposed in the handle.
